(19) United States
(12) Patent Application Publication
(10) Pub. No.: US 2022/0325684 A1
(43) Pub. Date: Oct. 13, 2022

(54) AIR SEPARATOR-ENHANCED COMBUSTION SYSTEMS

(71) Applicant: Christopher Thomas Lawhorn, Colorado Springs, CO (US)

(72) Inventor: Christopher Thomas Lawhorn, Colorado Springs, CO (US)

(21) Appl. No.: 17/658,478

(22) Filed: Apr. 8, 2022

Related U.S. Application Data
(60) Provisional application No. 63/172,916, filed on Apr. 9, 2021.
(60) Provisional application No. 63/226,404, filed on Jul. 28, 2021.

(51) Int. Cl. F02M 27/00; B01D 53/04; B01D 53/047; F02B 33/34; F02M 25/12

(52) U.S. Cl. CPC F02M 27/00; B01D 53/0446; B01D 53/047; F02B 33/34; F02M 25/12; B01D 2253/108; B01D 2257/102; B01D 2259/40003; B01D 2259/40009

(57) ABSTRACT

The disclosed invention includes systems and methods to improve the efficiency of combustion engines through the use of air separator technology. In some embodiments, a system for improving engine efficiency includes a compressor configured to take in a flow of ambient air and output a supply of pressurized air to one or more air separators. The air separator(s) produce a supply of oxygen enriched air, which is conveyed to the combustion chamber(s) of an engine. The air separators also produce a supply of exhaust air, which may be used to power system components, or other components. Other embodiments include methods of improving engine efficiency by pressurizing ambient air, supplying the pressurized air to an air separator to produce oxygen-enriched air, and supplying the enriched air to an engine's combustion chamber(s). Some embodiments use a supply of exhaust air from the air separator to power system components and other components.

### CROSS-REFERENCE TO RELATED APPLICATIONS

This application claims priority to U.S. Provisional Application No. 63/172,916, filed Apr. 9, 2021, and U.S. Provisional Application No. 63/226,404, filed Jul. 28, 2021, the disclosures of which are hereby incorporated by reference herein in their entirety.

### BACKGROUND OF THE INVENTION

### Field of the Invention

Embodiments of the disclosed invention relate, in general, to devices, systems, and methods that improve the efficiency of combustion systems by using air separators to supply oxygen rich air.

### Relevant Background

Air separator technology is well-established, and is used in many applications to include fire suppression systems, industrial inerting, tire inflation, food storage, and others. It has been used chiefly to produce nitrogen-rich air, only producing oxygen-rich air as a byproduct. The technology has advanced over the decades so that separator units are compact and can produce large volumes of separated air with low input pressures.

### BRIEF DESCRIPTION OF THE DRAWINGS

Features and objects of the disclosed invention and the manner of attaining them will become more apparent, and the invention itself will be best understood, by reference to the following description of one or more embodiments taken in conjunction with the accompanying drawings and figures imbedded in the text below and attached following this description.

The Figures imbedded and attached depict embodiments of the disclosed invention for purposes of illustration only. One skilled in the art will readily recognize from the following discussion that alternative embodiments of the structures and methods illustrated herein may be employed without departing from the principles of the invention described herein.

FIG. 1 depicts a membrane-type air separator for use as part of the disclosed invention.

FIG. 2 depicts the disclosed invention as used with an internal combustion engine.

FIG. 3 is a flow chart representing processes comprising the disclosed invention.

### DEFINITIONS

“Carnot efficiency” means a theoretical maximum amount of work that a heat engine can perform, and is based on the difference in temperature between a hot reservoir and a cold reservoir. Applied to an engine, such as an internal combustion engine, the Carnot efficiency of a given combustion cycle is estimated by the difference between the minimum temperature and the peak temperature of the engine.

### DETAILED DESCRIPTION OF THE INVENTION

The detailed description of the disclosed invention will be primarily, but not entirely, limited to devices, systems, and methods for improving the efficiency of combustion systems by supplying air to the combustion process having increased oxygen levels and reduced inert gas contents. Oxygen-rich air is supplied through the use of air separators traditionally used in e.g., fire suppression systems which require nitrogen-enriched, oxygen-depleted air. To improve combustion efficiency, the air separators are re-configured to supply oxygen-rich air to the combustion process, and re-route nitrogen-rich and otherwise inert air for other purposes.

The disclosed invention will now be described in detail with reference to several embodiments thereof as illustrated in the accompanying Figures. In the following description, numerous specific details are set forth in order to provide a thorough understanding of embodiments of the disclosed application. It will be apparent, however, to one skilled in the art that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

It should be apparent to those skilled in the art that the described embodiments of the disclosed invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Naturally occurring atmospheric air contains approximately 21 percent (%) oxygen (O₂), 78% nitrogen (N₂), with the remainder comprising mostly argon and carbon dioxide (CO₂). Air is a key component of the combustion process, a chemical reaction in which fuel reacts with O₂ in air to release energy, and produce CO₂, water (H₂O), and other byproducts. Nitrogen gas, which is by far the most plentiful component of air, is not required for combustion, but instead reduces its efficiency. Inert gases like N₂ reduce efficiency both at the beginning and during the combustion process. First, internal combustion engines are forced to exert work on the inert gases to compress them along with the O₂ and fuel prior to combustion. Then during combustion, the inert gases are heated along with the combustion components, which takes heat away from the fuel and oxygen, thereby reducing the peak temperature reached by the combustion process.

Therefore, removing N₂ and other inert gases from combustion processes improves efficiency at two stages of combustion. At the start of the process, reducing the inert gas content of air to be compressed will reduce the energy losses from compressing the gases not required for combustion. Then during combustion, reduced inert gases decrease the energy wasted on heating those gases, thus enabling higher peak temperatures. Such efficiency gains allow for engine modifications to improve the Carnot efficiency of the engine, the theoretical efficiency derived from comparing the engine's peak (hot) temperature to its minimum (cold) temperature. Carnot efficiency is improved by increasing the engine's maximum hot temperature, which can be facilitated by reducing the inert gas content of the intake air. Raw efficiency gains from reducing inert gas content in combustion is estimated to be between 20% and 60%.

Efficiency gains in the higher end of the range are enabled by engine modifications, such as increasing expansion ratio, that are available due to the higher intake O₂ content. In many cases, an engine's compression ratio may already be at or near limitations imposed by fuel breakdown pressure. In such cases, because of the use of oxygen-enriched intake air, an engine's expansion ratio may be increased on the exhaust stroke, and the compression ratio left unchanged. Increasing expansion ratio can be accomplished through changes in the cylinder volume ratio of top dead center (TDC) and bottom dead center (BDC). With the TDC or BDC modifications in place, intake valve operation timing may be modified to keep the compression ratio in an acceptable range. In one scenario, the intake valve can be shut early during the intake stroke, i.e., before the piston reaches the bottom of its travel. Such an early shut-off reduces air able to enter the cylinder, thereby reducing the effective volume used to calculate the compression ratio. In another scenario, the intake valve can be shut late after the piston passes bottom dead center and starts the compression stroke. This late shut-off allows some air to be expelled back into the intake manifold, again reducing the amount of air that is compressed for combustion and reducing the effective volume used for the compression ratio. In both scenarios, Carnot efficiency can be increased by the greater expansion ratio which will drive a greater difference in the peak hot and cold temperatures of the engine.

Efficiency gains from use of air separators are partially offset by inefficiencies introduced by increased weight from the air separators, air compression requirements, and heat and humidity limitations. Such inefficiencies are anticipated and addressed by embodiments of the disclosed invention so that net combustion efficiency is improved substantially.

Some embodiments of the disclosed invention accomplish the removal of inert, non-combustion gases from ambient air by use of membrane-type air separators. Such technology has evolved rapidly in recent years so that relatively simple, inexpensive, compact, lightweight, and robust air separators can produce sufficient levels of oxygen enrichment with relatively low required input pressures. Membrane-type separator technology typically pushes air through a dense membrane and separates its components by use of molecule size differentiation. A faster gas like oxygen, typically passes through the filter pores rapidly, while a slower gas like nitrogen typically passes through more slowly, and thus are carried further internally. To drive the gas separation, a certain amount of input pressure is required to push the air through the membrane.

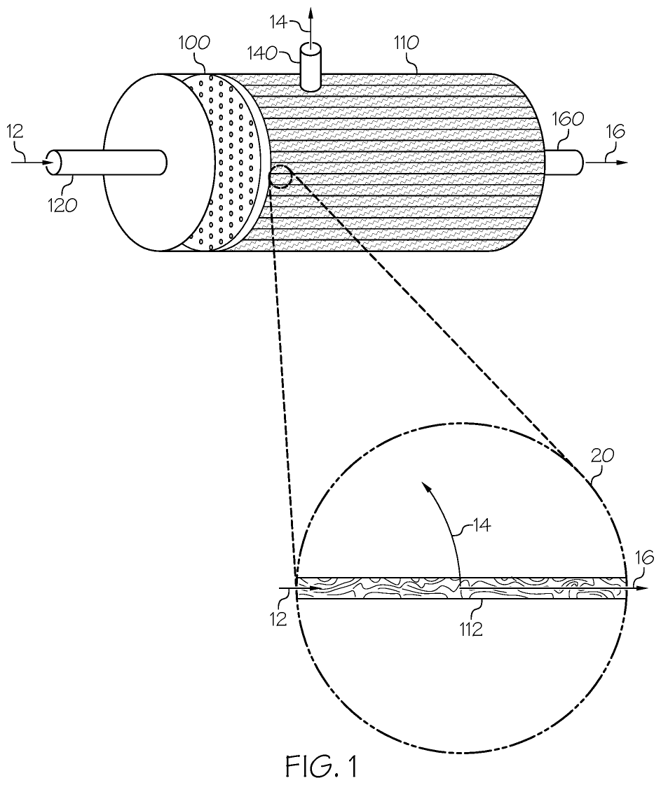

With reference to FIG. 1, air separator(s) 100 included in some embodiments of the disclosed invention include a bundle 110 of hollow polysulfide fiber membranes, each of which filters fast gases out of the flow of air passing through the fibers. A close-up of an individual hollow fiber 112 is depicted in the inset 20. When a pressurized air mixture 12 enters the inlet 120, the gas components separate based on their permeation rates through the fiber 112. Therefore, O₂ and other fast gases 14 permeate easily through the fiber walls and exit the side port 140. Nitrogen and other slow gases 16 find the fiber less permeable, and tend to travel down the internal channel of the fiber, finally exiting at the exhaust port 160. An example air separator suitable for the purposes of the disclosed invention is the Sepuran N₂ separator by Evonik Fibres, GmbH. This separator is 50 inches (in.) long, 4.5 in. diameter, and weighs 47 pounds. At 102 pounds per square inch gauge (psig) input pressure and 77 degrees Fahrenheit (° F.), the Sepuran is capable of producing 3.44 standard cubic feet per minute (SCFM) of enriched O₂ air. Generally, however, the performance specifications of comercially-available separators seek to optimize N₂ purity, which is not a relevant performance metric for the disclosed invention. Rather, increasing airflow into the separator, while decreasing the efficiency of N₂ production, improves O₂ purity and increases airflow from the side port 140 and hence into the engine. Therefore, when using separators for O₂ production, optimal input pressures and airflows must be determined. Separators designed to optimize O₂ production would improve performance as well, for example, a separator configured with a higher diameter and a shorter length would improve O₂ production. Other suitable modifications are possible and contemplated.

Other embodiments of the disclosed invention may use pressure swing adsorption air separators. Such air separators exploit the property of gases by which gases tend to adsorb, i.e., adhere, to certain surfaces in the presence of high pressures. When the pressure is reduced, the gas particles will release or desorb from the surface. Gas component separation is accomplished because different gases tend to adsorb to different materials with more or less affinity. For example, a zeolite surface attracts N₂ more strongly than O₂. Therefore, under pressure, the N₂ would adsorb to the zeolite and the air removed from the pressure vessel will tend to be richer in O₂ than ambient air. Once the zeolite surface is at capacity, the N₂ can be desorbed by lowering the pressure and flushing out the N₂. Pressure swing air separators may be used in embodiments for which reducing the size, weight and energy requirements of air separator components is less critical, such as for use in power plants, ships, or construction equipment, e.g., earth movers, excavators, bulldozers, cranes, tractors, etc.

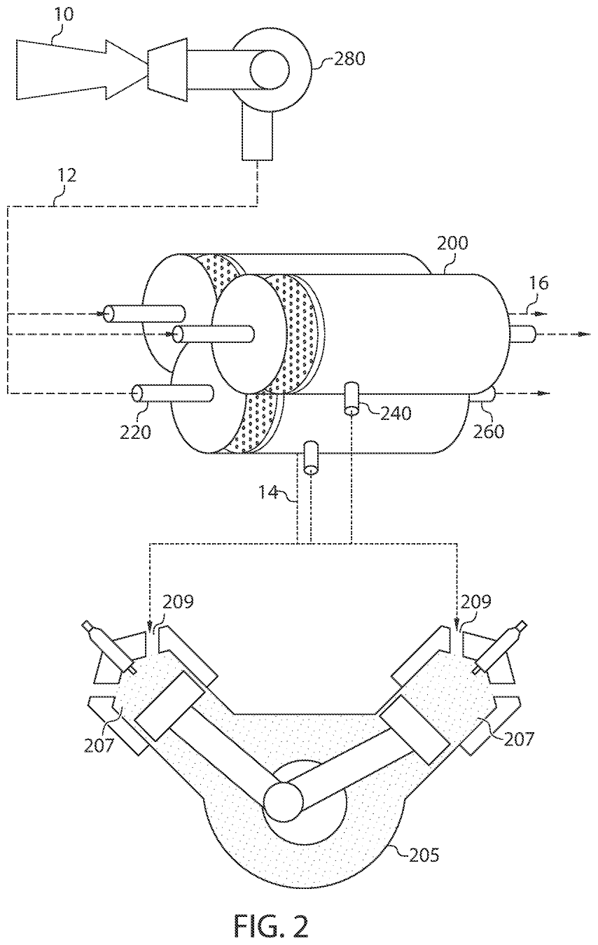

With reference to FIG. 2, an embodiment of the disclosed air separator-enhanced combustion system is depicted. In this example, one or more air separators 200 (three are shown) are used to supply oxygen-rich air to the combustion chambers 207 of an internal combustion engine (ICE) 205. Ambient air 10 is taken into a compressor 280 and pressurized. The compressor may be any type of air compressor suitable to the application. For example, ICEs used in an automobile may include a supercharger, a turbocharger, an electric compressor, or other compressor of suitable size, weight, power requirements, and output for the ICE. Larger engines, e.g., those used in ships, power plants, or construction equipment, may include a rotary screw compressor, reciprocating compressor, centrifugal compressor, an axial compressor, etc. Some embodiments may include alternative means to compress ambient air 10 before supplying it to the air separator 200, e.g., air may be compressed by ram air techniques, engine intake vacuum pressure, or other suitable technique. Other embodiments may not require air pressurization. The amount of pressure required to force air through the air separator need not be at levels specified in product specifications for nitrogen production. Instead, use of such separators for oxygen production may benefit from lower input pressures, which reduces system energy requirements, improving overall efficiency.

Use of membrane-type air separators in embodiments of the disclosed invention poses certain challenges depending on the application. For example, typical membrane-type air separators require low humidity to operate efficiently, and may not work at all under 100% humidity conditions. Accordingly, some embodiments may include a dehumidifier (not shown) to dry the air before it enters the air separator. A dehumidifier may process air prior to compression or prior to being supplied to the inlet(s) 220. Additionally, air separators may have low maximum operating temperatures, e.g., 115° F., so compressed air 12 may require a cooling step before it enters the separator 200.

Once the ambient air 10 is compressed 12, it is routed to the inlet(s) 220 of one or more air separator(s) 200 (three are shown) by one or more compressed air tubes or hoses (not shown). Conveyance of the supply of compressed air 12 is by any suitable means in the art, to include hoses or tubing made from rubber, nylon, plastic, metal, or other material configured to transport the pressurized and heated air 12 to the air separator 200. Preferably, the tubing is short, straight, and has an inner surface configured to promote efficient pressurized airflow. In embodiments using membrane-type air separators, the supply of pressurized air 12 passes into the hollow fiber membranes where O₂ passes quickly out of the fibers and is routed to the outlet port(s) 240. The N₂ that remains in the fibers and is routed out via the exhaust port(s) 260. A supply of oxygen-enriched air 14, i.e., air having greater than 21% O₂ content, is routed from the outlet(s) 240 to the combustion chamber(s) 207 (two are shown) of the ICE 205 by enriched air tubing (not shown). Conveyance of the enriched air 14 is by any suitable means in the art, to include tubing made from rubber, nylon, plastic, metal, or other material configured to transport the enriched air 14 to the combustion chamber(s) 207. Preferably, the tubing is short, straight, and has an inner surface configured to promote efficient airflow. In some embodiments, the oxygen-enriched air is pressurized by a secondary compressor prior to reaching the engine. Ideally, the secondary compressor applies vacuum pressure to the outlet ports, improving the production of enriched air from the separators. Oxygen-enriched air 14 is delivered by the enriched air tubing to the air intakes 209 of the ICE 205. The ICE 205 operates more than 10%, more than 15%, more than 20%, more than 30%, more than 40%, and up to 60% more efficiently by compressing and combusting only oxygen-enriched air 14. Meaning that an engine using the disclosed invention can produce more work per unit of fuel burned.

A flow of nitrogen-rich, oxygen-depleted exhaust 16, i.e., air having less than 21% O₂ content, is routed from the exhaust port(s) 260 away from the ICE 205. Such air 16 will exit the air separator 200 under pressure, therefore, it possesses energy that may be extracted to recover some of the energy used to compress the ambient air 10. Some embodiments use the exhaust air 16 for power generation, e.g., to operate a turbine, while other embodiments may use the exhaust for pressurized air 12 cooling, engine cooling, passenger/operator compartment cooling, or other suitable use.

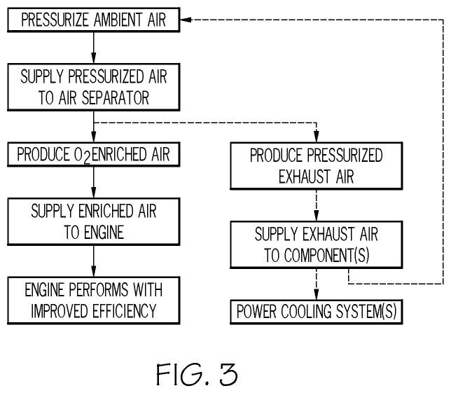

With reference to FIG. 3, a flow chart depicting steps in embodiments of the disclosed invention is shown. The invention first pressurizes ambient air, and then supplies the pressurized air to an air separator. The air separator produces a supply of oxygen enriched air, which is then supplied to an engine to facilitate fuel combustion, thereby improving efficiency. In some embodiments, the exhaust air from the air separator is used to recapture some of the energy needed to produce the oxygen enriched air, thereby improving overall system efficiency. This exhaust air may be used for a number of purposes, to include pressurizing the ambient air, powering cooling systems for the engine or passenger/cargo compartments, and other suitable uses. Additionally, exhaust air from the engine itself may be used to compress air or power cooling turbines, etc. to improve overall efficiency.

Embodiments of the disclosed invention may be used with a variety of ICEs and other combustion systems. For example, the disclosed system may improve the performance of different ICEs operating on various fuels, including gasoline, diesel, heavy fuel oil, natural gas, coal, kerosene, propane, natural gas, hydrogen, biofuels, other suitable alternative fuels, etc. Other combustion systems that may be improved by the disclosed invention include jet engines, turbine engines, rotary (Wankel) engines, fuel cells, and other engines that operate through the reaction of O₂ and fuel. The disclosed invention may improve the efficiency of combustion systems in automobiles, construction equipment, locomotives, tractors, boats, ships, fixed-wing aircraft, helicopters, as well as coal, oil, natural gas, and other combustible-fuel power plants.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The attached description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a nonexclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As will be understood by those familiar with the art, the disclosed invention may be embodied in other specific forms without departing from the spirit or essential characteristics thereof. Likewise, the particular naming and division of the modules, managers, functions, systems, layers, features, attributes, methodologies, and other aspects are not mandatory or significant, and the mechanisms that implement the invention or its features may have different names, divisions, and/or formats. Accordingly, the disclosure of the present invention is intended to be illustrative, but not limiting, of the scope of the invention.

This has been a description of the disclosed invention along with a preferred method of practicing the invention, however the scope of the inventions ought to be determined by the appended claims.

What is claimed is:

1. A system, comprising:
a compressor configured to take in a flow of ambient air and output a supply of pressurized air to the inlet(s) of one or more air separators, wherein each of the one or more air separators includes an inlet, and outlet, and an exhaust port;
wherein the one or more air separator(s) is configured to increase a concentration of oxygen in the supply of pressurized air, and is further configured to output a supply of enriched air from the outlet(s), wherein the enriched air has an oxygen concentration greater than 21 percent;
one or more hose(s) connecting the outlet(s) of the one or more air separators to one or more combustion chamber(s) of an engine; and
a flow of exhaust air exiting the exhaust port(s) of the one or more air separators.

2. The system of claim 1, wherein the compressor is one of the following: a supercharger, a turbocharger, an electric compressor, a rotary screw compressor, a reciprocating compressor, a centrifugal compressor, or an axial compressor.

3. The system of claim 1, wherein the one or more air separator(s) is one of the following types: a membrane type, or a pressure swing adsorption type.

4. The system of claim 1, wherein the engine is an internal combustion engine.

5. The system of claim 4, wherein the engine uses one of the following fuels: gasoline, diesel, heavy fuel oil, natural gas, gasified coal, or a biofuel.

6. The system of claim 4, wherein the engine has one or more cylinders, and wherein the engine is modified by one of the following: changing a cylinder volume ratio of top dead center of the one or more cylinders, or changing a cylinder volume ratio of bottom dead center of the one or more cylinders, and wherein an intake valve of the one or more cylinders is shut in one of the following ways: before a piston reaches a bottom point of its travel, or after the piston passes bottom dead center.

7. The system of claim 1, wherein the engine is one of the following: a jet engine, a turbine engine, or a Wankel engine.

8. The system of claim 1, further comprising: a means for using the flow of exhaust air as a supply of pressurized air for one of an electrical generator, or a turbine for cooling.

9. The system of claim 1, further comprising: a dehumidifier configured to reduce a moisture content of one or more of the following: the flow of ambient air, and the supply of pressurized air.

10. The system of claim 1, further comprising: an air cooler configured to reduce the temperature of the supply of pressurized air.

11. A method for improving the efficiency of an engine, the method comprising:
pressurizing a flow of ambient air;
delivering a supply of pressurized air to an air separator;
using the air separator to produce a supply of enriched air, wherein the enriched air is more than 21 percent oxygen; and
delivering the supply of enriched air to an engine;

12. The method of claim 11, wherein the ambient air is pressurized using a compressor;

13. The method of claim 11, wherein the air separator is one of the following types: a membrane-type, a pressure swing adsorption-type.

14. The method of claim 11, wherein the engine is an internal combustion engine.

15. The method of claim 14, wherein the engine has one or more cylinders, the method comprising:
modifying the engine in one of the following ways: changing a cylinder volume ratio of top dead center of the one or more cylinders, or changing a cylinder volume ratio of bottom dead center of the one or more cylinders;
adjusting a shut timing of an intake valve of the one or more cylinders in one of the following ways: before a piston reaches a bottom point of its travel, or after the piston passes bottom dead center.

16. The method of claim 11, further comprising:
using the air separator to produce a supply of exhaust air, wherein the supply of exhaust air is pressurized; and
providing the supply of exhaust air to an electrical generator, or to a turbine for cooling.

17. The method of claim 11, further comprising: reducing a moisture content of one or more of the following: the flow of ambient air, and the supply of pressurized air.

18. The method of claim 11, wherein the engine is one of the following: a jet engine, a turbine engine, or a Wankel engine.

19. The method of claim 11, wherein the engine powers one of the following: a ship, a power plant, a piece of construction equipment, an automobile, a locomotive, or an aircraft.

20. The method of claim 11, wherein the engine operates using one of the following fuels: gasoline, diesel, heavy fuel oil, natural gas, gasified coal, or a biofuel.
